(19) United States
(12) Patent Application Publication
(10) Pub. No.: US 2005/0216762 A1
(43) Pub. Date: Sep. 29, 2005

(54) Protecting embedded devices with integrated reset detection

(76) Inventor: Cyrus Peikari, Dallas, TX (US)

Correspondence Address: Cyrus Peikari, 6242 Walnut Hill Ln, Dallas, TX, 75230, US

(21) Appl. No.: 11/089,391

(22) Filed: Mar. 24, 2005

Related U.S. Application Data
(60) Provisional application No. 60/556,941, filed on Mar. 25, 2004.

(51) Int. Cl. H04L 9/00

(52) U.S. Cl. 713/200

(57) ABSTRACT

A system for optimizing the security of embedded, mobile devices such as personal data assistants and Smartphones by protecting against soft and hard reset code attacks. In a preferred embodiment, this is achieved by 1. Scanning the active memory for evidence of “hard reset attack” code. 2. Scanning the filesystem for evidence of “hard reset attack” code. 3. Scanning the active memory for evidence of “soft reset attack” code. 4. Scanning the filesystem for evidence of “soft reset attack” code. 5. Automatically blocking and cleaning the reset code, based on user preference. 6. Providing optional user control over which programs are allowed to write to the startup folder.

### REFERENCES

U.S. patents:
U.S. Pat. No. 5,842,002
Schnurer, et al.
Computer virus trap
Nov. 24, 1998
U.S. Pat. No. 5,398,196
Chambers
Method and apparatus for detection of computer viruses
Mar. 14, 1995
U.S. Pat. No. 5,379,414
Adams
Systems and methods for FDC error detection and prevention
Jan. 3, 1995
U.S. Pat. No. 5,278,901
Shieh, et al
Pattern-oriented intrusion-detection system and method
Jan. 11, 1994
U.S. Pat. No. 5,121,345
Lentz
System and method for protecting integrity of computer data and software
Jun. 9, 1992

U.S. patent applications:
20030033536
Pak, Michael C.; et al
Virus scanning on thin client devices using programmable assembly language
Feb. 13, 2003
20020083334
Rogers, Antony John; et al.
Detection of viral code using emulation of operating system functions
Jun. 27, 2002
20030079145
Platform abstraction layer for a wireless malware scanning engine
Kouznetsov, Victor; et al.
Apr. 12, 2002

### CROSS-REFERENCE TO RELATED APPLICATIONS

Ser. No. 09/847,571
Self-optimizing the diagnosis of data processing systems by flexible multitasking
Peikari, Cyrus
May 2, 2001
60/476,259
Protecting embedded processing systems with real-time, heuristic, integrated virus scanning
Peikari, Cyrus
Jun. 4, 2003
60/497,113
Protecting Data Processing Systems with Distributed, Bayesian, Heuristic Malware Detection
Peikari, Cyrus
Aug. 22, 2003

### STATEMENT REGARDING FEDERALLY SPONSORED RESEARCH OR DEVELOPMENT

Not Applicable

### FIELD OF THE INVENTION

The invention relates to the protection of data processing systems. In particular, the invention is directed to increasing the security of embedded, mobile computing devices, especially by protecting against malicious code such as computer viruses, worms and Trojan horses that cause data corruption and data loss.

### BACKGROUND OF THE INVENTION

Computer processing systems (such as a desktop computers and computer networks) are vulnerable to malicious code and programs such as computer viruses, worms and Trojan horses. A common method of protection against malicious code involves using protection programs such as a virus scanner. For example, the most common form of virus scanner operates by scanning data in binary files for unique strings or signatures of unique byte sequences.

Recently, embedded, mobile devices such as personal data assistants (PDAs) and advanced mobile phones (smartphones) are becoming prevalent. In fact, embedded operating systems are beginning to allow even miniature devices like watches and toasters to run advanced software and to communicate using wireless radio frequency (RF). Like their desktop computing counterparts, these tiny devices are also vulnerable to malicious programming code such as computer viruses. In fact, the first viruses and Trojans for smartphones and PDAs have already appeared.

Embedded platforms such as Windows CE power handheld devices such as Windows® Mobile Smartphone and Pocket PC. Unfortunately, the Windows CE platform, because of its special embedded design, has unique security vulnerabilities. Smartphones and PDAs that run the Windows CE operating system are vulnerable new types of attack.

One of these attacks makes use of a native software command to perform a “hard reset” of the Windows CE device. A “hard reset” wipes all of the files and data that are stored in RAM, which is the primary storage media on these devices. There has already appeared a case of a software example that performs this type of attack. Trojans exist that are packaged as an innocent program, but when executed they perform a hard reset and wipe all of the user's important data. Worse, this “hard reset attack” occurs instantly, with no warning. Because this is an entirely new class of vulnerability, the prior art has no defense whatsoever against this devastating kind of attack.

Yet another, new attack against embedded devices that run Windows CE is the “startup logic bomb”. In this attack, an application such as a Trojan adds malicious code to the startup folder of the device. This hostile code might include a program that performs a “soft reset”, which is somewhat equivalent to a reboot on a traditional desktop computer, but is entirely unique to Windows CE devices. By adding the soft reset to the startup folder, the device continually reboots at startup and becomes unusable. In this new attack the user cannot terminate the rebooting loop, since the Windows CE startup folder is different from a desktop startup folder. On Windows CE, the startup folder loads earlier in the boot sequence and before many critical parts of the device have loaded. Since the soft reset is a new feature of Windows CE devices, the prior art has no defense against this kind of attack either.

In order to overcome this limitation of the prior art, the current invention incorporates a unique file-scanning engine that specifically scans the Windows CE device for hard reset attack code. This engine blocks hard reset attacks before they are executed in memory, and also cleans all instances of the malicious code from the device automatically. In addition, the current invention protects against soft reset logic bombs by preventing unauthorized writing to the Windows CE startup folder. The user has the option to decide what programs are allowed to write to the startup folder.

In the first example, suppose the user unknowingly downloads a virus or Trojan to his PDA. This Trojan contains hidden hard reset attack code which, when executed, instantly destroys all of the user's data and files. If, however, was using the system of the present invention, which has the ability to detect the hard reset attack code in memory, the system would intercept the attack code before it is executed. The system does this by continually scanning the active memory in real time. In addition, the system of the present invention tracks down and deletes or quarantines any remaining hard reset attack code in the file system. This is accomplished by using a unique signature, unknown in the prior art, that detects this special hard reset attack code.

In the second example, suppose the user unknowingly downloads a different virus or Trojan to his PDA. This new Trojan contains hidden logic bomb attack code that, when executed, writes soft reset code to the Windows CE startup folder. Thus, when the user boots his PDA, the first thing that is launched from the start folder is the code to perform a “soft reset”. This soft reset is unique to embedded devices such as Windows CE Pocket PC PDAs. This soft reset code causes the PDA to boot again. However, when the PDA boots again, it is caught again in the cycle of launching the same soft rest (reboot) code. Thus, the PDA is caught in a “logic bomb”. The device keeps rebooting until the battery dies, or until the user performs a hard reset, either of which will cause irretrievable loss of all data and files. If the user is running the system of the present invention, which has the ability to block files from being written to the startup folder with out the user's permission, any unwanted soft resets may be prevented. In addition, the invention provides the user the option to track down and delete or quarantines any remaining soft reset attack code in the file system. Our invention does this by using a special signature, again unknown to the prior art, which detects this special soft reset attack code.

In an alternate embodiment of the above examples, the current invention traps calls to the operating system that contain hard reset or soft reset code. The current invention interposes a software-based “embedded driver” between upper layers (applications) and the system kernel. The embedded driver then intercepts all system calls from upper layers applications and the system kernel. The embedded driver compares this called data against known soft-reset or hard-rest attack code. The embedded driver can then block or allow the code to pass from the application to the kernel, based on user preference.

### SUMMARY OF THE INVENTION

The present invention overcomes the disadvantages of the prior art, by offering a method and apparatus for protecting against hard or soft reset attack code.

This embodiment can be achieved by the following preferred system for:
a) Scanning the active memory for evidence of“hard reset attack” code.
b) Scanning the filesystem for evidence of “hard reset attack” code.
c) Scanning the active memory for evidence of “soft reset attack” code.
d) Scanning the filesystem for evidence of“soft reset attack” code.
e) Automatically blocking and cleaning the reset code, based on user preference.
f) Providing optional user control over which programs are allowed to write to the startup folder.

In an alternate embodiment of the current invention, a software-based “embedded driver” is placed between the application layer and the underlying kernel layer. This alternate embodiment is achieved by:
a) Interposing an embedded driver between the upper layer applications and the underlying system kernel.
b) Intercepting all system calls from upper level applications to the underlying kernel.
c) Comparing system calls against known attack code (such as soft reset or hard reset attack code).
d) Blocking or allowing the system call, based on user preference.

### BRIEF DESCRIPTION OF THE DRAWINGS

The present invention may be understood more clearly from the following detailed description, which is solely for explanation and should not be taken to limit the invention to any specific form thereof, taken together with the accompanying drawings, wherein:

FIG. 1 illustrates the preferred embodiment of the present invention, wherein the present invention monitors the volatile memory (RAM), the filesystem, and the startup folder for hard or soft reset code, and gives the user optional control over automatically blocking and deleting vs. permitting the reset code.

FIG. 2 illustrates an alternate embodiment of the present invention, wherein the present invention interposes a software-based “embedded driver” between the upper system layers (application layer) and the lower operating system layer (kernel layer). The embedded driver intercepts all system calls from the above applications to the kernel below. If the system call contains known attack code (such as soft reset or hard reset attack code), the embedded driver will blocking or allow the system call, based on user preference.

### DETAILED DESCRIPTION OF THE INVENTION

The operation of the present invention will now be described in conjunction with the Drawing Figures.

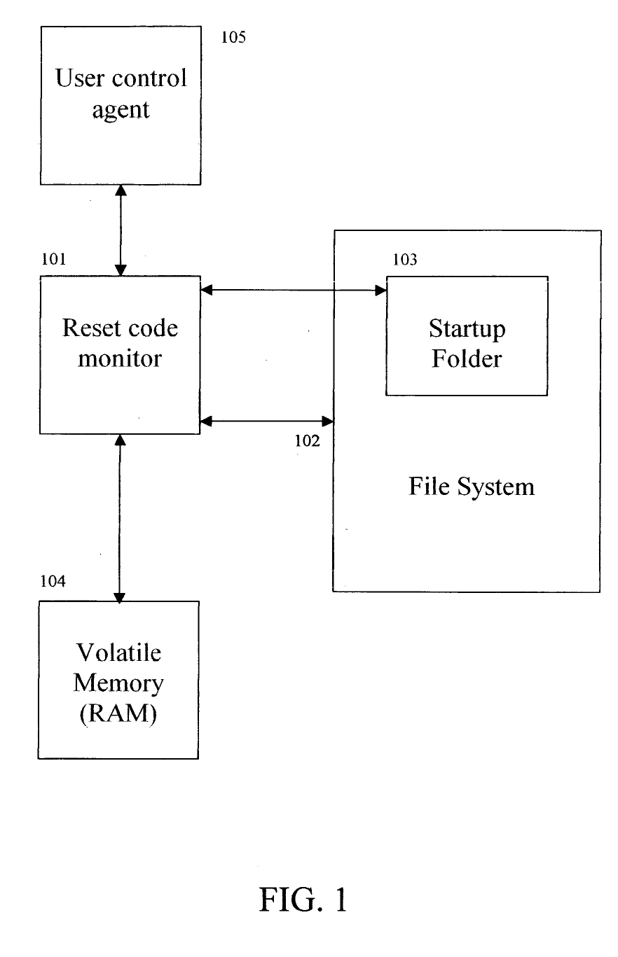

FIG. 1 illustrates the preferred embodiment of the present invention.

At step 101, the present invention is a software agent known as the “reset code monitor”. This reset code monitor at step 101 continually monitors the file system at step 102 for any soft-reset or hard-reset attack code. If the monitor at step 101 detects any reset code in the file system at step 102, the monitor at step 101 can automatically block and delete the reset code. The user control agent at step 105 can control the behavior of the monitor at step 101. Thus, The user control agent at step 105 can direct the monitor at step 101 to automatically block and delete the reset code. The user control agent at step 105 can also direct the monitor at step 101 to ask the user what to do with the detected reset code.

The monitor at step 101 also scans the volatile memory (RAM) at step 104 for any soft-reset or hard-reset attack code. If the monitor at step 101 detects any reset code in the file system at step 102, the monitor at step 101 can automatically block and delete the reset code. The user control agent at step 105 can control the behavior of the monitor at step 101. Thus, The user control agent at step 105 can direct the monitor at step 101 to automatically block and delete the reset code. The user control agent at step 105 can also direct the monitor at step 101 to ask the user what to do with the detected reset code.

The monitor at step 101 also scans a specific part of the filesystem known as the “startup folder” at step 103. The monitor at step 101 can detect any new programs or shortcuts written to the startup folder at step 103. The monitor at step 101 can then scan the newly written program or its shortcuts at step 103 for any link to soft or hard reset code. This prevents the continual startup reset-attack (described above) that was unknown in the prior art. The user control agent at step 105 can also control the behavior of the monitor at step 101. Thus, The user control agent at step 105 can direct the monitor at step 101 to automatically block and delete the reset code. The user control agent at step 105 can also direct the monitor at step 101 to ask the user what to do with the detected reset code.

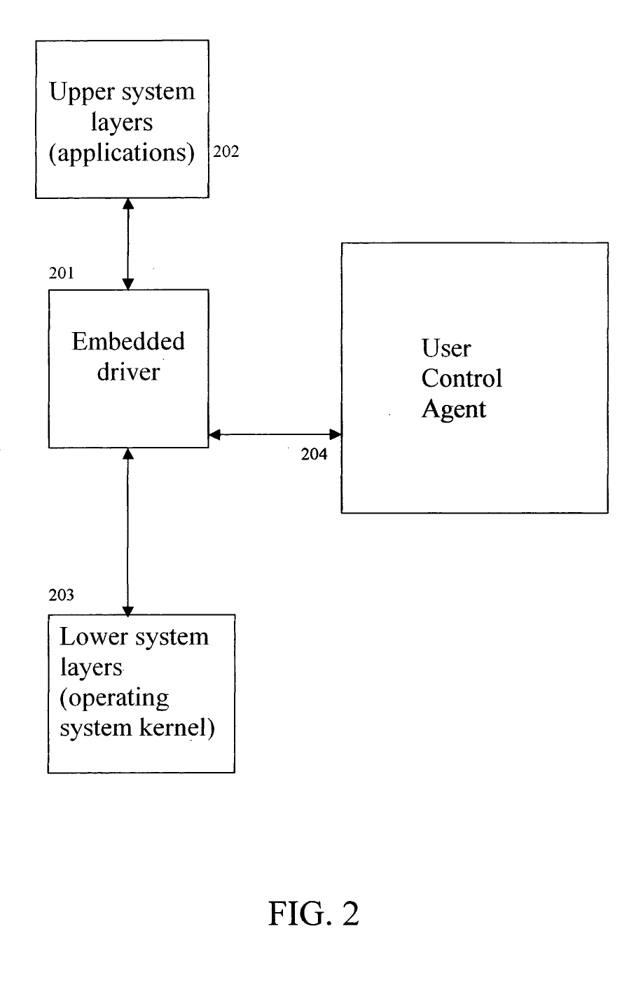

FIG. 2 illustrates an alternate embodiment of the present invention.

At step 201, a software-based embedded driver runs on the device. This driver intercepts all system calls from the upper system layers (applications) at step 202 to the lower system layers (kernel) at step 203. If the embedded driver detects any known reset code, the embedded driver can automatically block and delete or permit the code, based on user preference entered at step 204.

1. A method for protecting a data processing system against malicious code, comprising the steps of:
A. scanning an active memory for evidence of a hard reset code;
B. scanning a filesystem for evidence of a hard rest code;
C. scanning said active memory for evidence of a soft reset code;
D. scanning said filesystem for evidence of a soft reset code;
wherein, if any evidence of reset code is discovered during the scanning operations of steps a through d:
E. blocking and cleaning the reset code.

2. The method of claim 1, wherein steps A through D are repeated continuously.

3. The method of claim 1, wherein step E is performed automatically.

4. The method of claim 1, wherein step E is performed in response to a user selection.

5. The method of claim 1, wherein the user is provided with optional control over which programs are allowed to write to a startup folder.

6. The method of claim 1, wherein the data processing system is incorporated onto a personal data assistant.

7. A method for protecting against malicious code, comprising the steps of:
A. scanning an active memory for evidence of a hard reset code;
B. scanning a filesystem for evidence of a hard rest code;
wherein, if any evidence of reset code is discovered during the scanning operations of steps A and B:
C. blocking and cleaning the reset code.

8. The method of claim 7, wherein steps A and B are repeated continuously.

9. The method of claim 7, wherein step C is performed automatically.

10. The method of claim 7, wherein step C is performed in response to a user selection.

11. The method of claim 7, wherein the user is provided with optional control over which programs are allowed to write to a startup folder.

12. The method of claim 7, further comprising:
D. scanning said active memory for evidence of a soft reset code; and
E. scanning said filesystem for evidence of a soft reset code.

13. A method for protecting against malicious code, comprising the steps of:
A. scanning an active memory for evidence of a soft reset code;
B. scanning an filesystem for evidence of a soft reset code;
wherein, if any evidence of reset code is discovered during the scanning operations of steps A and B:
C. blocking and cleaning the reset code.

14. The method of claim 13, wherein steps A and B are repeated continuously.

15. The method of claim 13, wherein step C is performed automatically.

16. The method of claim 13, wherein step C is performed in response to a user selection.

17. The method of claim 13, wherein the user is provided with optional control over which programs are allowed to write to a startup folder.

18. The method of claim 13, further comprising:
D. scanning said active memory for evidence of a hard reset code; and
E. scanning said filesystem for evidence of a hard rest code.

19. An apparatus for protecting a data processing system against malicious code, comprising:
a. means for scanning an active memory for evidence of a hard reset code;
b. means for scanning a filesystem for evidence of a hard rest code;
c. means for scanning said active memory for evidence of a soft reset code;
d. means for scanning said filesystem for evidence of a soft reset code;
e. means for blocking and cleaning any reset code.

20. The apparatus of claim 19, further comprising an embedded, mobile device.
